(19) United States
(12) Patent Application Publication
(10) Pub. No.: US 2011/0004725 A1
(43) Pub. Date: Jan. 6, 2011

(54) DATA STORAGE DEVICE AND METHOD

(75) Inventor: Shigeyoshi TANAKA, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/827,767

(22) Filed: Jun. 30, 2010

(30) Foreign Application Priority Data
Jul. 2, 2009 (JP) 2009-158151

(51) Int. Cl. G06F 12/00; G06F 12/02

(52) U.S. Cl. 711/103; 711/112; 711/166; 711/E12.001; 711/E12.008

(57) ABSTRACT

According to one embodiment, a data storage device, includes: a recording medium, statuses of storage areas of the recording medium being managed by groups; a managing table storage module storing a managing table in which bit information pieces are associated to indexes representing the groups, the bit information pieces indicating the statuses of the storage areas initially set to an erased status; a transfer controller storing, upon receiving a write command, data in the storage areas; and a controller updates the bit information pieces of one of the groups to which the storage areas belongs to a stored status. Upon receiving an erase command, the transfer controller overwrites the storage areas by predetermined data. The main controller is configured to update the bit information pieces to the erased status.

### CROSS-REFERENCE TO RELATED APPLICATIONS

This application is based upon and claims the benefit of priority from Japanese Patent Application No. 2009-158151, filed Jul. 2, 2009, the entire contents of which are incorporated herein by reference.

### FIELD

One embodiment relates to a data storage device and a method.

### BACKGROUND

Conventionally, a magnetic disk device such as a hard disk drive (HDD) has been widely used as a storage device for a computer. The storage capacity of a magnetic disk device is growing every year, and those with a storage capacity of a terabyte (TB) have been making an appearance.

Recently, a magnetic disk device has often been recycled. Thus, it is desired to make data stored in a recycled magnetic disk device unreadable by any third person to prevent leakage of any personal information or secret information when the device is disposed or repaired.

Accordingly, there has been developed a method for erasing data stored in a recycled magnetic disk device by overwriting the data with meaningless data. However, an enormous time is required to erase a magnetic disk device with increased capacity.

Accordingly, there has been proposed to provide a managing table in which access histories for each data sector are recorded. The histories of data writing process are recorded in the managing table based on a write instruction issued from a host. Then, when an erase command is issued from the host, only the histories of data writing process are erased from the managing table. As a result, the data stored in the recycled magnetic disk device can be made unreadable by any third person just by erasing the histories, thereby the erasing process can be speed up.

However, the conventional technologies described above are not sufficient to prevent the data leakage because the data itself remains in the recycled magnetic disk device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a HDD according to a first embodiment;

FIG. 2 is an exemplary schematic diagram of a magnetic recording medium in the first embodiment;

FIG. 3 is an exemplary schematic diagram of a data structure of a cylinder number in the first embodiment;

FIG. 4 is an exemplary schematic diagram of a managing table in the first embodiment;

FIG. 5 is an exemplary flowchart of writing process performed by the HDD in the first embodiment;

FIG. 6 is an exemplary flowchart of erasing process performed by the HDD in the first embodiment;

FIG. 7 is an exemplary block diagram of a HDD according to a second embodiment;

FIG. 8 is an exemplary schematic diagram of a data structure of a head number and a track number in the second embodiment;

FIG. 9 is an exemplary schematic diagram of a managing table in the second embodiment;

FIG. 10 is an exemplary flowchart of erasing process performed by the HDD in the second embodiment;

FIG. 11 is an exemplary block diagram of a HDD according to a third embodiment;

FIG. 12 is an exemplary schematic diagram of a magnetic recording medium in the third embodiment;

FIG. 13 is an exemplary schematic diagram of a data structure of a cell number in the third embodiment;

FIG. 14 is an exemplary flowchart of erasing process performed by the HDD in the third embodiment;

FIG. 15 is an exemplary block diagram of a HDD according to a fourth embodiment;

FIG. 16 is an exemplary diagram of a data structure of a logical address in the fourth embodiment;

FIG. 17 is an exemplary schematic diagram of a managing table in the fourth embodiment; and

FIG. 18 is an exemplary flowchart of erasing process performed by the HDD in the fourth embodiment.

### DETAILED DESCRIPTION

In general, according to one embodiment, a data storage device, comprises: a recording medium, statuses of storage areas of the recording medium being managed by a plurality of predetermined groups; a managing table storage module configured to store therein a managing table in which bit information pieces are associated to indexes representing the groups, the bit information pieces indicating the statuses of the storage areas belonging to each of the groups, the bit information pieces being initially set to an erased status indicating that no data is written thereto; a transfer controller configured to transfer, upon receiving a write command instructing to write data to the recording medium from a higher-level device, the data to the recording medium to store the data in at least one of the storage areas; and a main controller configured to update at least one of the bit information pieces of one of the groups to which the at least one of the storage areas belongs to a stored status indicating that the data is stored in the at least one of the storage areas, wherein upon receiving an erase command instructing to initialize the recording medium from the higher-level device, the transfer controller is configured to transfer predetermined data to the recording medium to overwrite the at least one of the storage areas by the transferred data, and the main controller is configured to update the at least one of the bit information pieces updated to the stored status to the erased status.

According to another embodiment, a data erasing method, comprises: upon receiving a write command instructing to write data to a recording medium from a higher-level device, transferring the data to the recording medium to store the data in at least one of storage areas of the recording medium, statuses of the storage areas being managed by a plurality of predetermined groups; updating at least one of bit information pieces of one of the groups to which the at least one of the storage areas belongs to a stored status indicating that the data is stored in the at least one of the storage areas, the bit information pieces being associated to indexes representing the groups in a managing table of a managing table storage module, the bit information pieces indicating the statuses of the storage areas belonging to the groups, the bit information pieces being initially set to an erased status indicating that no data is written to the storage areas; upon receiving an erase command instructing to initialize the recording medium from the higher-level device, transferring predetermined data to the recording medium to overwrite the at least one of the storage areas by the transferred data; and updating the at least one of the bit information pieces updated to the stored status to the erased status.

In the embodiments described hereinafter, the data storage device is explained as, for example, a hard disk drive (HDD). However, the data storage device is not limited thereto.

To begin with, an overview of a HDD according to the embodiments will be explained.

The HDD according to the embodiments uses a managing table to manage statuses of storage areas of a magnetic recording medium by a plurality of predetermined groups. The storage areas store data therein. In the managing table, bit information pieces are associated with indexes representing the respective groups. The bit information pieces indicate the statuses of the storage areas belonging to the groups.

Upon receipt of an instruction to write data, the HDD stores the instructed data in at least one of the storage areas of the magnetic recording medium, and at the same time, updates at least one of the bit information pieces of one of the groups to which the at least one of the storage areas belongs to a stored status.

Upon receipt of an instruction to initialize data, the HDD overwrites the data stored in the at least one of the storage areas with predetermined data, and updates the at least one of the bit information pieces of the one of the groups to which the at least one of the storage areas overwritten with the predetermined data belongs to an erased status.

As described above, the HDD of the embodiments uses the managing table to manage the statuses of the storage areas of the magnetic recording medium. Hence, upon receipt of the instruction to initialize the data, only the storage areas to which the data is stored can be initialized. Accordingly, it becomes possible to prevent the data leakage, while speeding up the data erasing process.

In an example explained in a first embodiment, information on a plurality of upper bits of a cylinder number of a magnetic recording medium is used as the indexes representing the groups in which the statuses of the storage areas of the magnetic recording medium are managed. In the explanation in the first embodiment, a cylinder/head/sector (CHS) type HDD in which a hard disk is accessed using three parameters that are the number of cylinders, the number of heads, and the number of sectors, is used as an example.

To begin with, a structure of the HDD according to the first embodiment will be explained.

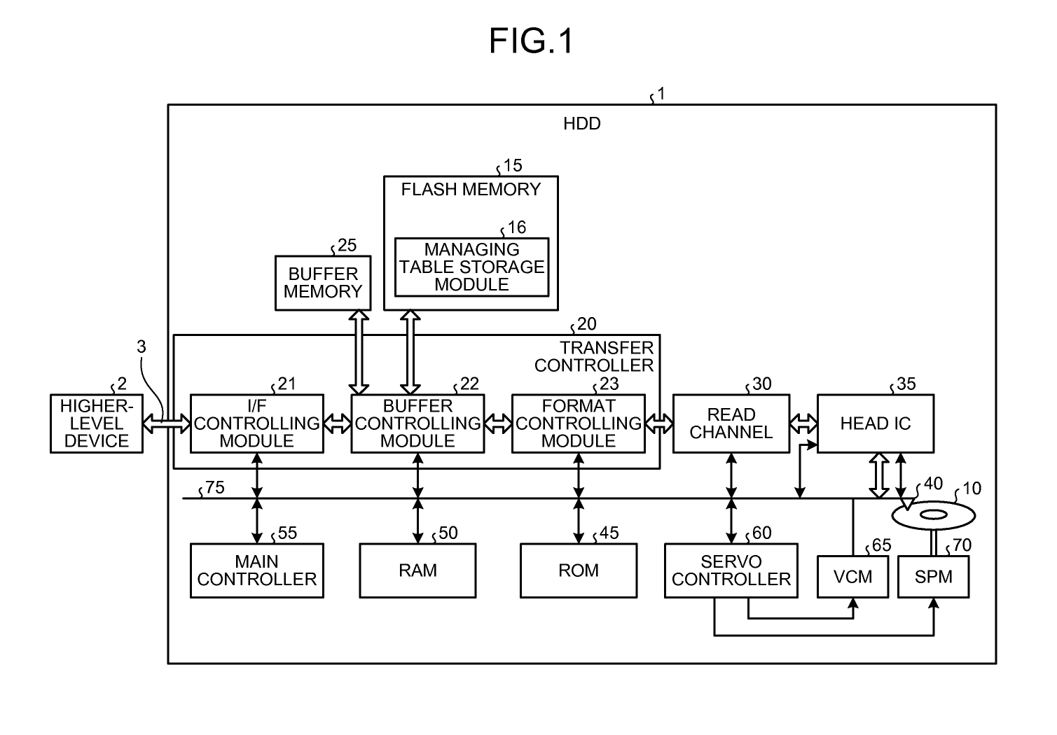

FIG. 1 is a block diagram illustrating an exemplary structure of a HDD 1 according to the first embodiment. As illustrated in FIG. 1, the HDD 1 is connected to a higher-level device 2, such as a personal computer (PC), via a host interface 3. The HDD 1 comprises a magnetic recording medium 10, a flash memory 15, a transfer controller 20, a buffer memory 25, a read channel 30, a head integrated circuit (IC) 35, a head 40, a read-only memory (ROM) 45, a random access memory (RAM) 50, a main controller 55, a servo controller 60, a voice coil motor (VCM) 65, and a spindle motor (SPM) 70.

The magnetic recording medium 10 is a disk-like substrate made of metal or glass with magnetic film formed thereon, and the statuses of storage areas thereof for storing data is managed by predetermined groups.

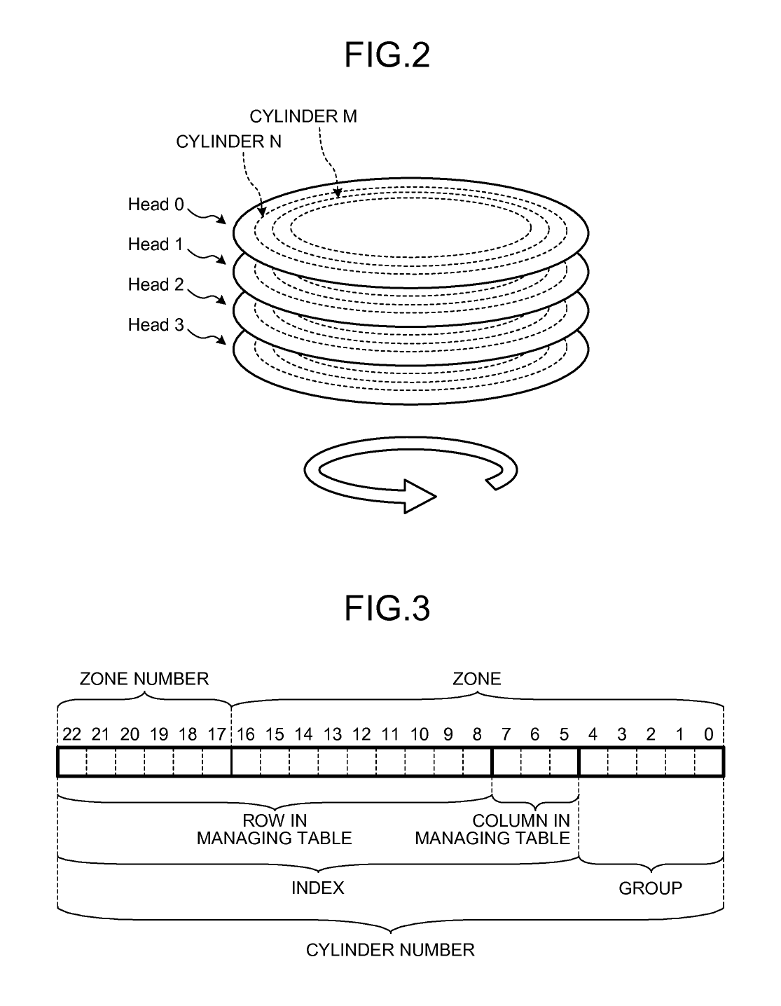

FIG. 2 is a schematic diagram of an example of the magnetic recording medium 10 according to the first embodiment, and illustrates recording surfaces of two disks as four surfaces. The HDD 1 according to the first embodiment is a CHS model as mentioned earlier, and in the example illustrated in FIG. 2, a position to which data is recorded (a storage area) is specified by a head number corresponding to each of the recording surfaces (heads 0 to 3), a physical cylinder number (cylinders M, N, . . . ), and a sector number (not illustrated) that is sequentially scanned by rotation of the disk. In the first embodiment, the statuses of the storage areas of the magnetic recording medium 10 are managed by a plurality of predetermined groups, and each of the groups comprises a plurality of cylinders.

Referring back to FIG. 1, the flash memory 15 is a non-volatile memory, and stores therein a conversion table in which logical addresses of the magnetic recording medium 10 are associated to physical addresses of the magnetic recording medium 10, or the like. The flash memory 15 may be either a parallel type, or a serial type. The flash memory 15 comprises a managing table storage module 16.

The managing table storage area 16 stores therein a managing table in which indexes representing the groups are associated with bit information pieces, respectively. In the groups, the statuses of the storage areas of the magnetic recording medium 10 are managed, and the bit information pieces represent the statuses of the storage areas belonging to the groups. The bit information pieces in the managing table are to be updated to an erased status indicating that no data is written thereto before the device is shipped, so that all of the bit information pieces are initially set to the erased status. In the managing table, when data is stored in the magnetic recording medium 10, at least one of the bit information pieces of one of the groups comprising at least one of the storage areas to which the data is stored is updated to a stored status indicating that the data is stored therein.

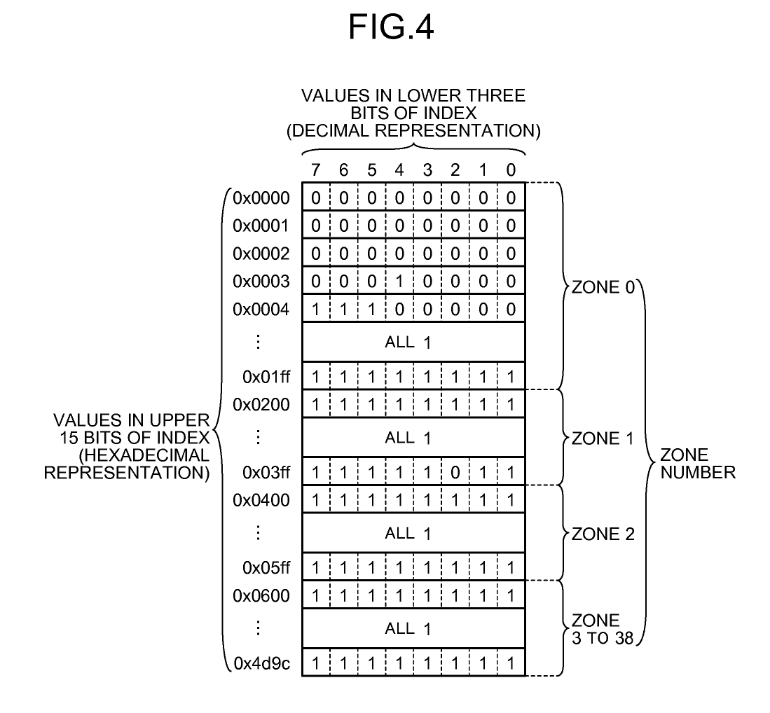

The managing table according to the first embodiment will now be explained more specifically. The managing table according to the first embodiment uses information on a plurality of upper bits of a cylinder number of the magnetic recording medium 10 as the indexes representing the groups in which the statuses of the storage areas in the magnetic recording medium 10 are managed. FIG. 3 is a schematic diagram illustrating an example of a data structure of the cylinder number in the magnetic recording medium 10, and FIG. 4 is a schematic diagram illustrating an example of the managing table according to the first embodiment.

Assuming that the storage capacity of the magnetic recording medium 10 is 1 Terabyte (10¹² Bytes), and the sector size is 512 Bytes, for example, the maximum value of the logical address in the magnetic recording medium 10 would be 0x746a5288 (1 Terabyte/512 Bytes) in the hexadecimal representation. Assuming that the number of sectors in the innermost track is 64, the number of sectors in the outermost track is 128, and the recorded surfaces are four in the magnetic recording medium 10 as illustrated in FIG. 2, the maximum cylinder number in the magnetic recording medium 10 would be 0x4d9c37 in the hexadecimal representation, as expressed by formula (1).

$$\begin{matrix}Maximum Cylinder Number = 0 \times 746 a 5288 / 4 / \{ ( 64 + 128 ) / 2 \} \\ = 0 \times 4 d 9 c 37\end{matrix} \qquad ( 1 )$$

Therefore, in this example, as the number of bits representing the cylinder number in the magnetic recording medium 10, 23 bits would be required as illustrated in FIG. 3. In the managing table illustrated in FIG. 4, the cylinders represented by the lower five bits (the zeroth to the fourth bits) of the cylinder number illustrated in FIG. 3, that is, 32 cylinders are placed in one group, and values in the upper 18 bits (the fifth to the twenty-second bits) of the cylinder number are used as the indexes representing the groups.

To explain in more detail, in the managing table illustrated in FIG. 4, the statuses of the storage areas belonging to the groups represented by the indexes are managed by the values in the upper 15 bits (the eighth to the twenty-second bits of the cylinder number) of the index in the row, and the values in the remaining three bits (the fifth to the seventh bits of the cylinder number) in the column thereof. For example, in the managing table illustrated in FIG. 4, the bit information with a value 0x0000 in the row and a value 0 in the column manages the statuses of cylinders 0x000000 to 0x00001f.

In the example illustrated in FIG. 4, the bit information piece representing the erased status is set to “1”, and the bit information piece representing the stored status is set to “0”. In other words, the managing table illustrated in FIG. 4 indicates that the cylinders 0x000380 to 0x00039f, 0x0004a0 to 0x03ff3f, and 0x03ff60 to 0x4d9cff store therein no data. Similarly, the managing table illustrated in FIG. 4 indicates that the cylinders 0x000000 to 0x00037f, 0x0003a0 to 0x00049f, and 0x03ff40 to 0x03ff5f stores therein data.

In the managing table illustrated in FIG. 4, the cylinders represented by the lower five bits of the cylinder number illustrated in FIG. 3 are placed in one group; however, the unit (size) of the group is not limited thereto. In a recent HDD, to keep the recording density in the magnetic recording medium approximately constant, the storage areas in the magnetic recording medium are divided into zones and the recording speed is changed therein. Therefore, upon crossing the zones, circuit constants such as a clock or a filter need to be changed. Thus, it is preferable not to make a group across a boundary of the zones. In the managing table illustrated in FIG. 4, the cylinders represented by the lower 17 bits of the cylinder number illustrated in FIG. 3 are grouped into one zone, and the values in the upper six bits of the cylinder number are used as a zone number indicating the zone.

In the example illustrated in FIG. 4, the values in the upper 15 bits of the index are used in the row of the managing table, and the values in the remaining three bits are used in the column thereof; however, the managing table is not limited thereto, and the values in the upper 14 bits of the index may be used in the row of the managing table, and the values in the remaining four bits may be used in the column thereof, for example.

Referring back to FIG. 1, the transfer controller 20 controls data transfer between the higher-level device 2 and the magnetic recording medium 10, and can be realized by a hard disk controller (HDC), for example. Upon receiving a write command instructing to write data from the higher-level device 2, for example, the transfer controller 20 transfer the write data to the magnetic recording medium 10 to have the data stored in the storage area.

Upon receiving an erase command instructing to initialize the magnetic recording medium 10 from the higher-level device 2, for example, the transfer controller 20 transfers predetermined data to the magnetic recording medium 10 to overwrite the storage areas belonging to one of the groups associated with the bit information piece that is updated to the recorded status (that is, to “0”). Therefore, in the example illustrated in FIG. 4, the transfer controller 20 causes the cylinders 0x000000 to 0x00037f, 0x0003a0 to 0x00049f, and 0x03ff40 to 0x03ff5f to be overwritten with the predetermined data. The predetermined data may be any data, for example, “00”, “ff”, “00” and “ff” repeated, or random numbers.

The transfer controller 20 comprises an interface (I/F) controlling module 21, a buffer controlling module 22, and a format controlling module 23.

The I/F controlling module 21 is connected to the higher-level device 2 via the host interface 3 to control communications with the higher-level device 2. The buffer controlling module 22 controls the flash memory 15 and the buffer memory 25. The buffer controlling module 22 temporarily stores data, for example, transferred between the higher-level device 2 and the magnetic recording medium 10 in the buffer memory 25.

The format controlling module 23 performs, for example, an error check of data transferred between the higher-level device 2 and the magnetic recording medium 10. Upon writing data, the format controlling module 23 accepts the data from the higher-level device 2 via the I/F controlling module 21, appends an error correction code and the like to the data, and outputs the data to the read channel 30 to be described later. Upon reading data, the format controlling module 23 accepts data from the read channel 30, performs the error check to the data as required, and outputs the data to the buffer controlling module 22.

The read channel 30 performs an analog/digital (AD) conversion, modulation, and demodulation of the data that is transferred between the higher-level device 2 and the magnetic recording medium 10. Upon writing data, the read channel 30 modulates a code of data input from the format controlling module 23. Upon reading data, the read channel 30 amplifies a data signal output from the head IC 35 to be described hereunder, and provides predetermined processes such as the AD conversion and the demodulation thereto.

The head IC 35 comprises a preamplifier not illustrated, and upon reading data, pre-amplifies a data signal read by the head 40 to be described hereunder from the magnetic recording medium 10. The head 40 floats above the rotating magnetic recording medium 10 to write and to store write data to and in the magnetic recording medium 10, and to read data stored in the magnetic recording medium 10.

The ROM 45 stores therein predetermined control programs such as firmware programs and various control data. The RAM 50 is used by the main controller 55, to be described hereunder, as a working memory, and the control programs and the control data stored in the ROM 45 are expanded thereon.

The main controller 55 controls each of the modules in the HDD 1 based on the control programs and the like stored in the ROM 45, and can be realized by a micro processing unit (MPU), a central processing unit (CPU), or the like. More specifically, the main controller 55 analyzes various commands such as a write command, an erase command, or a read command notified from the higher-level device 2 via the I/F controlling module 21, and controls each of the modules in the HDD 1 based on contents of the analyzed command to control reading and writing data from and to the magnetic recording medium 10 comprehensively.

The main controller 55 can control the flash memory 15 via the buffer controlling module 22. To store the write data transferred to the magnetic recording medium 10 by the transfer controller 20 in the storage areas, for example, the main controller 55 updates at least one of the bit information pieces of one of the groups comprising the storage area in which the write data is stored to the stored status (that is, to “0”).

To overwrite at least one of the storage areas belonging to one of the groups associated with at least one of the bit information pieces that is updated to the recorded status (that is, to “0”) with the predetermined data transferred to the magnetic recording medium 10 by the transfer controller 20, for example, the main controller 55 updates the at least one of the bit information pieces updated to the recorded status to the erased status (that is, to “1”). Therefore, the main controller 55 updates the bit information pieces of the one of the groups comprising the cylinders 0x000000 to 0x00037f, 0x0003a0 to 0x00049f, and 0x03ff40 to 0x03ff5f from “0” to “1” in the example illustrated in FIG. 4.

Physical characteristics of flash memory deteriorates when data stored therein is repeatedly updated. However, since the bit information pieces in the managing table is updated only once from the erased status to the stored status during the period between when the device is shipped and when the data stored in the magnetic recording medium 10 is erased, the deterioration of the flash memory rarely occurs.

The servo controller 60 drives the VCM 65 and the SPM 70 to be described hereinafter according to instructions from the main controller 55. The VCM 65 is a head driving mechanism that is driven by the servo controller 60 to rotate an arm (not illustrated) connected to the head 40 on the magnetic recording medium 10. The SPM 70 is a mechanism driven by the servo controller 60 to rotate the magnetic recording medium 10.

The I/F controlling module 21, the buffer controlling module 22, the format controlling module 23, the read channel 30, the head IC 35, the ROM 45, the RAM 50, the main controller 55, and the servo controller 60 are connected to a shared bus 75, and various data is passed between each of the modules via the shared bus 75.

An operation performed by the HDD according to the first embodiment will now be explained.

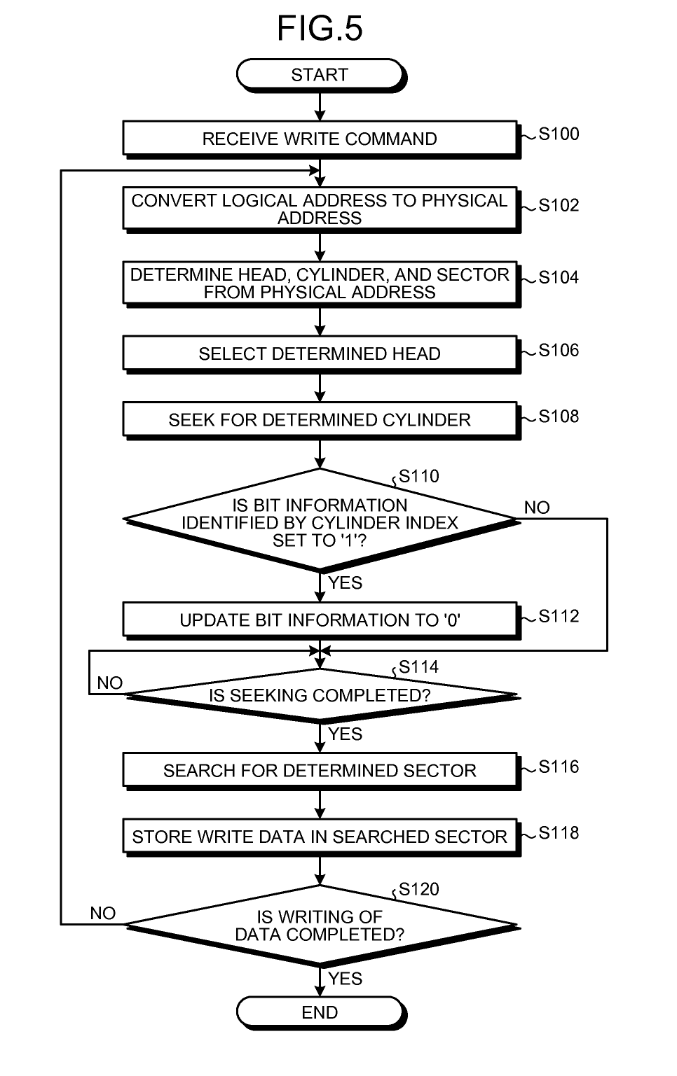

FIG. 5 is a flowchart indicating writing process performed by the HDD 1 according to the first embodiment.

To begin with, the transfer controller 20 receives a write command that is sent from the higher-level device 2, and notifies the command to the main controller 55 (S100). To be more in detail, the transfer controller 20 receives a write command together with write data and a logical address of the magnetic recording disk 10 indicating where the write data is to be written, for example; notifies the write command and the logical address and so on to the main controller 55; and stores the write data in the buffer memory 25.

The main controller 55 then refers to a conversion table stored in the flash memory 15 to convert the logical address of the magnetic disk 10 to a physical address thereof (S102).

The main controller 55 then determines the cylinder and the sector to which the write data is to be written, and the head 40 to be used for writing the data based on the converted physical address (S104).

The main controller 55 then controls the servo controller 60 to cause the VCM 65 to select the head 40 determined at S104 (S106).

The main controller 55 then controls the servo controller 60 to cause the VCM 65 to move the head 40 selected at S106, and starts seeking the cylinder determined at S104 (S108).

The main controller 55 then refers to the managing table stored in the managing table storage module 16 to check if the bit information piece represented by the index of the cylinder to which the write data is to be written is set to ‘1’ (S110).

If the bit information piece is set to ‘1’ (Yes at S110), the main controller 55 updates the bit information piece to ‘0’ (S112). If the bit information piece is not set to ‘1’ (that is, set to ‘0’), the process at S112 is not performed (No at S110).

The main controller 55 then waits for the seeking to complete (No at S114). Upon completion of the seeking (Yes at S114), the main controller 55 searches for the sector determined at S104 via the head IC 35 (S116).

The transfer controller 20 then transfers the write data stored in the buffer memory 25 to the magnetic recording medium 10 via the read channel 30, the head IC 35, and the head 40 to have the write data stored in the searched sector (S118).

Upon completing writing of the write data (Yes at S120), the main controller 55 ends the process. If writing of the write data is not completed (No at S120), the main controller 55 proceeds to S102.

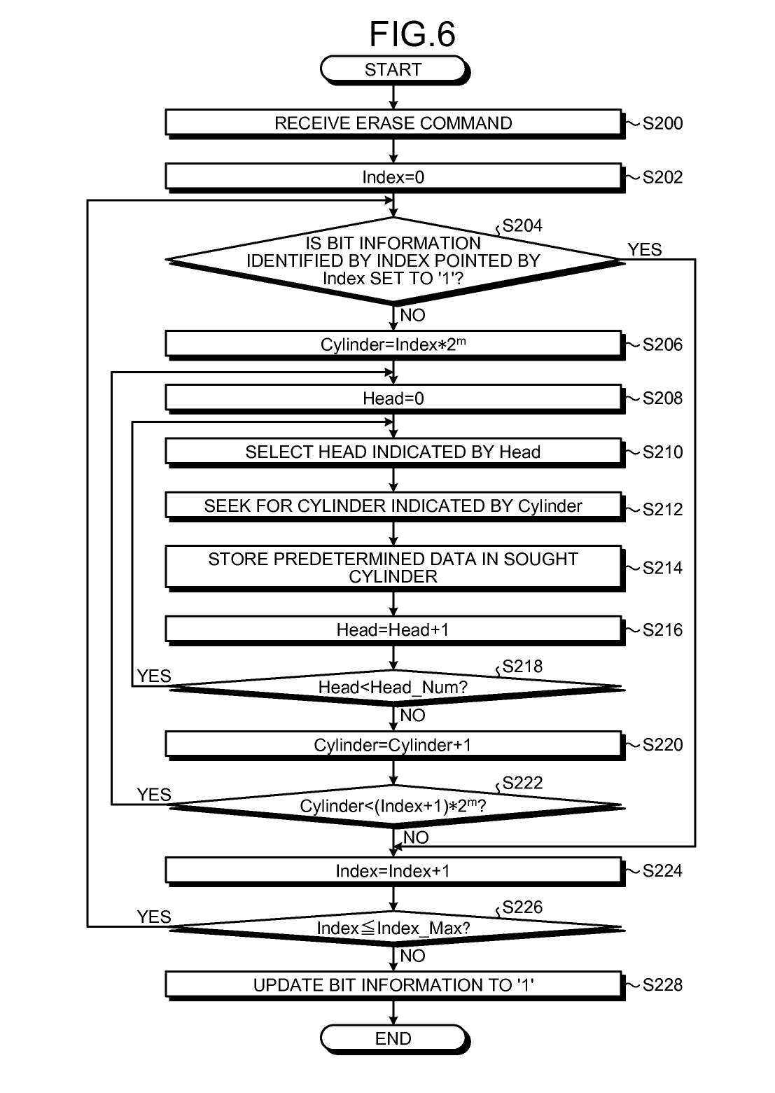

FIG. 6 is a flowchart indicating erasing process performed by the HDD 1 according to the first embodiment.

To begin with, the transfer controller 20 receives an erase command sent from the higher-level device 2, and notifies the command to the main controller 55 (S200).

The main controller 55 then initializes the value of Index that is a variable indicating the index to 0 (S202).

The main controller 55 then refers to the managing table stored in the managing table storage module 16 to check if the bit information piece represented by the index identified by the Index is set to ‘1’ (S204). If the bit information piece is set to ‘1’ (Yes at S204), the system control proceeds to S224.

If the bit information piece is not set to ‘1’ (that is, set to ‘0’) (No at S204), the main controller 55 sets a value of Cylinder that is a variable indicating the cylinder number to Index*2^{m} (S206). 2^{m} herein is a value representing the number of the cylinders in one group, and in the first embodiment, m is set to 5.

The main controller 55 then initializes the value of Head that is a variable indicating a head number to 0 (S208).

The main controller 55 then controls the servo controller 60 to cause the VCM 65 to select the head 40 indicated by the Head (S210).

The main controller 55 then controls the servo controller 60 to cause the VCM 65 to move the head 40 selected at S210, and starts seeking the cylinder indicated by the Cylinder (S212).

Upon completing seeking, the transfer controller 20 then transfers the predetermined data to the magnetic recording medium 10 via the read channel 30, the head IC 35, and the head 40 to have the predetermined data stored in the sought cylinder (S214).

The main controller 55 then increments the value of the Head (S216). If the incremented value of the Head is smaller than Head_Num (Yes at S218), the main controller 55 repeats the processes at S210 to S216. The Head_Num is a value indicating the number of the heads, and in the first embodiment, the value is 4.

If the value of the Head becomes equal to or more than the Head_Num (No at S218), the main controller 55 increments the value of the Cylinder (S220). If the incremented value of the Cylinder is smaller than (Index+1)*2^{m} (Yes at S222), the main controller 55 repeats the processes at S208 to S220. (Index+1)*2^{m} is a value indicating the maximum value of the cylinder number in the cylinders belonging to the group represented by the index identified by the Index.

If the value of the Cylinder becomes equal to or more than (Index+1)*2^{m} (No at S222), the main controller 55 increments the value of the Index (S224). If the incremented value of the Index is equal to or less than Index_Max (Yes at S226), the main controller 55 repeats the processes at S204 to S224. The Index_Max is a value indicating the maximum value of the index.

When the value of the Index exceeds the Index_Max (No at S226), the main controller 55 updates the value of the bit information piece that is set to ‘0’ to ‘1’, among the bit information pieces in the managing table stored in the managing table storage module 16 (S228).

As described above, in the first embodiment, the statuses of the storage areas in the magnetic recording medium are managed using the managing table. Accordingly, upon receipt of the instruction to initialize data, storage areas that have stored therein data can only be initialized. In this manner, the data leakage can be prevented and the data erasing process can be speed up.

In general, a HDD that is to be recycled often includes a HDD returned or given to others because it does not satisfy expectations of a user or a HDD mistakenly assumed to be broken. In other words, not all of the storage areas in the HDD are used. The technique disclosed herein is effective for such HDD.

Furthermore, in the first embodiment, the managing table is stored in the flash memory. Hence, even if the power or the like fails during the writing operation, the managing table can be prevented from being inconsistent. The throughput can be prevented from being deteriorated as well, unlike the situation in which the managing table is stored in the magnetic recording medium.

Furthermore, in the first embodiment, the size of the managing table can be adjusted according to the number of bits in the cylinder number that is set to the index and a size of the group. Hence, degree of freedom of use can advantageously be increased. For example, the size of the group can be increased to reduce the size of the managing table; or the size of the group can be reduced to manage the statuses of the magnetic recording medium more precisely.

The time required for the erasing process may be calculated before performing the erasing process based on the number of bits indicating the erased status in the managing table, and may be notified to a user.

In the example explained in the first embodiment, information on a plurality of upper bits of the cylinder number is used as the indexes that represent the groups in which the statuses of the storage areas in the magnetic recording medium are managed. In a recent HDD, the recording density is highly optimized and the track density differs in each of the recording surfaces of the magnetic recording medium. Hence, the storage areas are not considered in terms of cylinder, but in fact, a logical block address (LBA) is assigned in a manner following the order of the head numbers to determine a physical position based on the track number and the head number on each of the medium surfaces.

In a second embodiment, information on bits of the head number of the magnetic recording medium and information on a plurality of upper bits in the track number thereof are used as the indexes representing the groups in which the statuses of the storage areas of the magnetic recording medium are managed. In the explanation below, differences with the first embodiment are mainly explained, and structural elements having the same function as those in the first embodiment will be given the same names and the same reference numerals as those in the first embodiment, and explanations thereof will be omitted.

To begin with, a structure of a HDD according to the second embodiment will be explained.

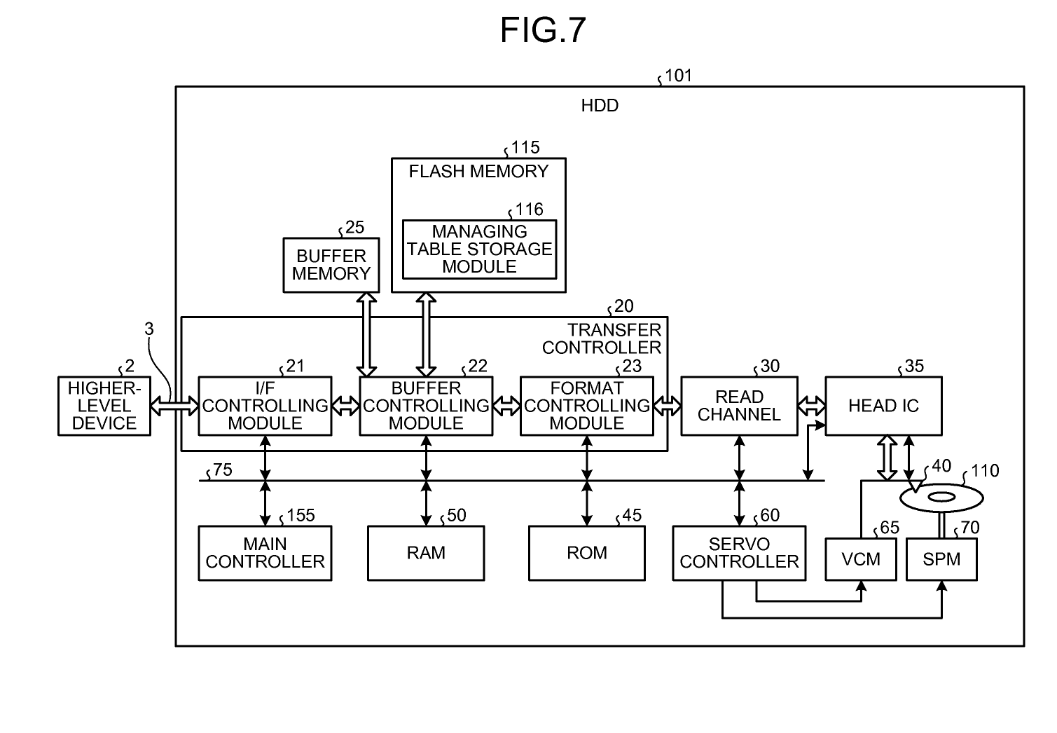

FIG. 7 is a block diagram illustrating an exemplary structure of a HDD 101 according to the second embodiment. The HDD 101 illustrated in FIG. 7 is different from the HDD 1 according to the first embodiment in having a magnetic recording medium 110, a managing table storage area 116 in a flash memory 115, and a main controller 155. Therefore, the magnetic recording medium 110 and the managing table storage area 116, which are the main differences between the first and the second embodiments, will be explained below. An explanation of the main controller 155 will be omitted in the description of the structure of the HDD, and will be given with reference to an operation performed by the HDD that is to be described hereunder.

In the magnetic recording medium 110, statuses of storage areas storing therein data is managed by predetermined groups. In the second embodiment, each of the groups comprises a plurality of tracks.

The managing table storage area 116 stores therein a managing table in which indexes representing the groups are associated with the bit information pieces representing the statuses of the storage areas belonging to the groups. In the groups, the storage areas of the magnetic recording medium 110 are managed.

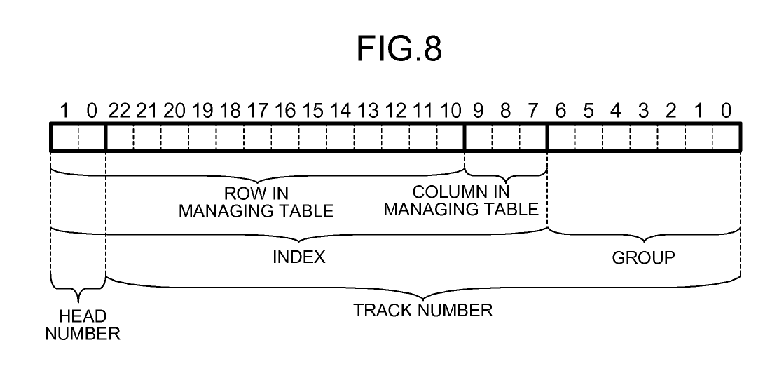

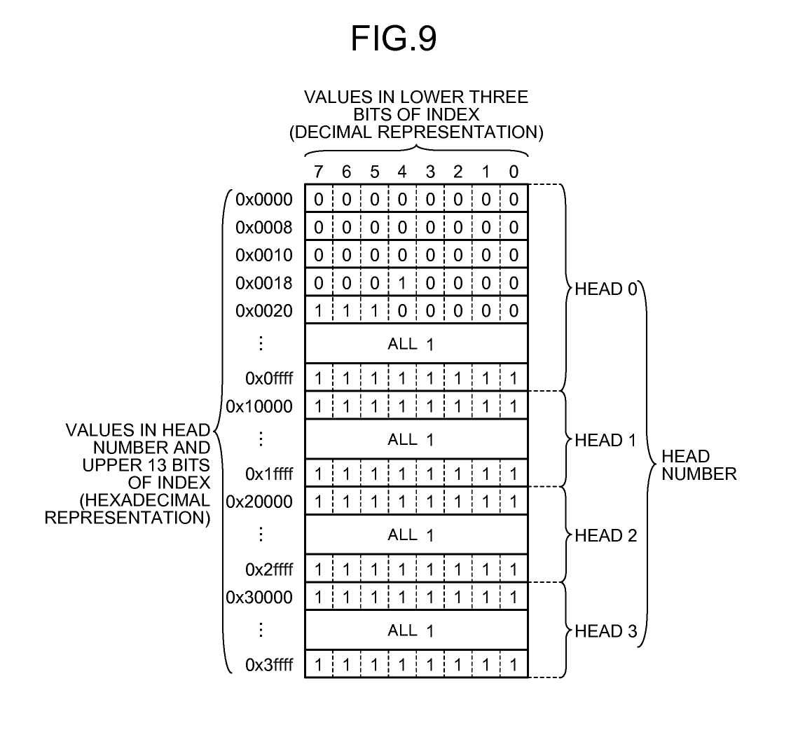

The managing table according to the second embodiment will now be explained more specifically. The managing table according to the second embodiment uses the information on the bits of the head number and the information on a plurality of upper bits of the track number of the magnetic recording medium 110 as the indexes representing the groups in which the statuses of the storage areas in the magnetic recording medium 110 are managed. FIG. 8 is a schematic diagram illustrating an example of a data structure of the head number and the track number in the magnetic recording medium 110, and FIG. 9 is a schematic diagram illustrating an example of the managing table according to the second embodiment.

The number of bits representing the head number of the magnetic recording medium 110 is two bits as illustrated in FIG. 8, and the number of bits representing the track number is 23 bits as illustrated in FIG. 8. In the managing table illustrated in FIG. 9, the tracks represented by the lower seven bits (the zeroth to the sixth bits) of the track number illustrated in FIG. 8, that is, 128 tracks are placed in one group, and values in the two bits (the zeroth to the first bits) of the head number and the upper 16 bits (the seventh to the twenty-second bits) of the track number are used as the indexes representing the groups.

To explain in more detail, in the managing table illustrated in FIG. 9, the statuses of the storage areas belonging to the groups represented by the indexes are managed by using the values in the two bits of the head number and the upper 13 bits in the index (the tenth to the twenty-second bits of the track number) in the row, and the values in the remaining three bits (the seventh to the ninth bits of the track number) in the column. In the five-digit value in the row of the managing table illustrated in FIG. 9, the value in the upper digit corresponds to the two-bit value of the head number, and the values in the lower four digits correspond to the values in the upper 13 bits in the index. For example, in the managing table illustrated in FIG. 9, the bit information piece having the value 0x00000 in the row and 0 in the column manages the status of the tracks 0x000000 to 0x00008f on the recording surface corresponding to the head having the head number 0.

In the example illustrated in FIG. 9, the bit information of the erased status is set to “1”, and the bit information of the stored status is set to “0”. In other words, the managing table illustrated in FIG. 9 indicates that the tracks 0x001200 to 0x00127f, and 0x001680 to 0x4fffff on the recording surface corresponding to the head number 0 and all of the tracks on each of the recording surfaces corresponding to the head numbers 1 to 3 do not store therein any data. Similarly, the managing table illustrated in FIG. 9 indicates that the tracks 0x000000 to 0x0011ff, and 0x001280 to 0x00168f on the recording surface corresponding to the head number 0 have stored therein some data.

An operation performed by the HDD according to the second embodiment will now be explained. The writing process performed in the HDD 101 according to the second embodiment is the same as that indicated in the flowchart of FIG. 5 with the cylinders replaced with the tracks; therefore, an explanation thereof is omitted herein.

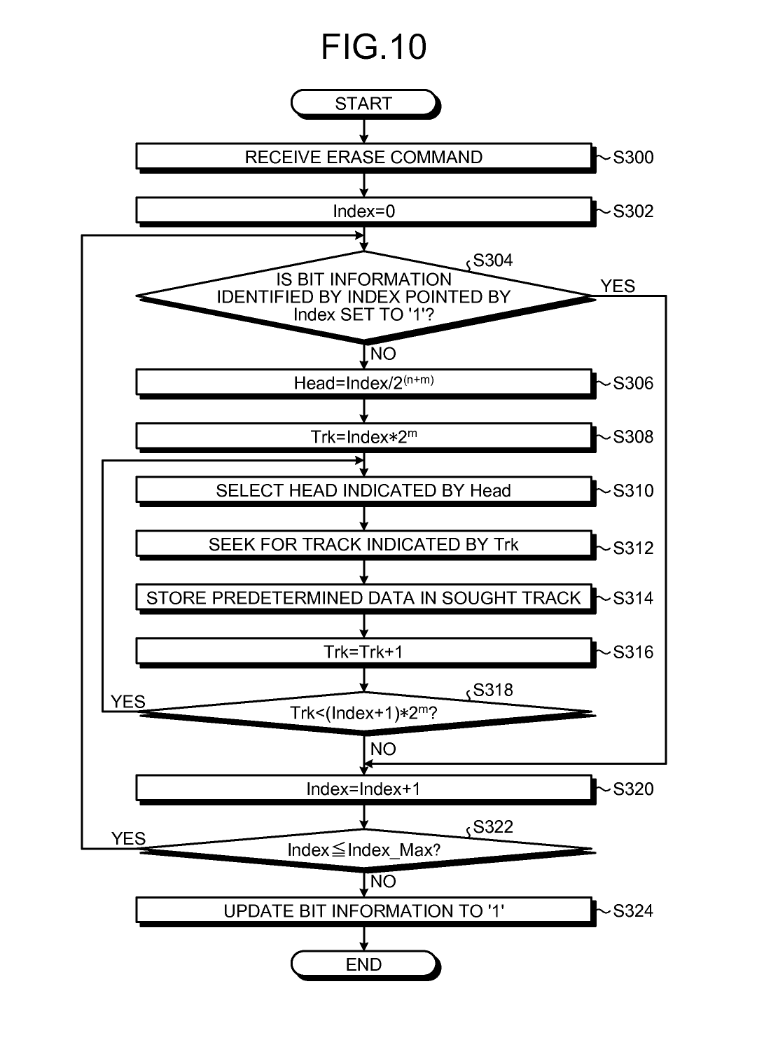

FIG. 10 is a flowchart indicating an erasing process performed by the HDD 101 according to the second embodiment.

The processes at S300 to S304 are the same as those at S200 to S204 in the erasing process indicated in FIG. 6. At 5304, if the bit information piece is set to ‘1’ (Yes at S304), the system control proceeds to S320.

If the bit information piece is not set to ‘1’ (that is, set to ‘0’) (No at S304), the main controller 155 sets the value of Head that is a variable indicating the head number to Index/2^{(n+m)} (S306). n herein represents the number of bits in the track number used for the index, and m represents the number of bits in the track number used for the group. In other words, n+m represents the number of bits in the track number, and in the second embodiment, n is 16 and m is 7.

The main controller 155 then sets the value of Trk that is a variable indicating the track number to Index*2^{m} (S308). 2^{m} is a value indicating the number of tracks in one group.

The main controller 155 controls the servo controller 60 to cause the VCM 65 to select the head 40 indicated by the Head (S310).

The main controller 155 then controls the servo controller 60 to cause the VCM 65 to move the head 40 selected at S310, and starts seeking the track indicated by the Trk (S312).

Upon completing seeking, the transfer controller 20 transfers the predetermined data to the magnetic recording medium 110 via the read channel 30, the head IC 35, and the head 40 to have the predetermined data stored in the sought track (S314).

The main controller 155 then increments the value of the Trk (S316). If the incremented value of the Trk is smaller than (Index+1)*2^{m} (Yes at S318), the main controller 155 repeats the processes at S310 to S316. (Index+1)*2^{m} is a value indicating the maximum value of the track number of the tracks belonging to the group pointed by the index identified by the Index.

If the value of the Trk becomes equal to or more than (Index+1)*2^{m} (No at S318), the main controller 155 increments the value of the Index (S320).

The subsequent processes at S322 to S324 are the same as those at S226 to S228 in the erasing process indicated in FIG. 6.

As described in the second embodiment, even when the HDD is not considered in terms of cylinders, the statuses of the storage areas of the magnetic recording medium can be managed by using the information on the bits of the head number and the information on the plurality of the upper bits of the track number of the magnetic recording medium as the indexes representing the groups in which the statuses of the storage areas of the magnetic recording medium are managed. Therefore, even in the HDD according to the second embodiment, upon receipt of to the instruction to initialize data, storage areas that have stored therein data can only be initialized. In this manner, the data leakage can be prevented, as well as the data erasure can be speed up.

In the example explained in the first embodiment, the information on a plurality of upper bits of the cylinder number is used as the indexes representing the groups in which the statuses of the storage areas in the magnetic recording medium are managed. In a recent HDD, in view of the recording density being highly optimized and the track density being different in each of the recording surfaces of the magnetic recording medium, a cell structure is often adopted. In the cell structure, a plurality of tracks having an approximately same interval therebetween is grouped across a plurality of recording surfaces, and the LBAs are assigned thereto to determine a physical position.

Thus, in an example explained in a third embodiment, information on a plurality of upper bits in the cell number of the magnetic recording medium is used as the indexes representing the groups in which the statuses of the storage areas in the magnetic recording medium are managed. In the explanation below, differences with the first embodiment will mainly be explained, and structural elements having the same function as those in the first embodiment will be given the same names and the same reference numerals as those in the first embodiment, and explanations thereof will be omitted.

To begin with, a structure of a HDD according to the third embodiment will be explained.

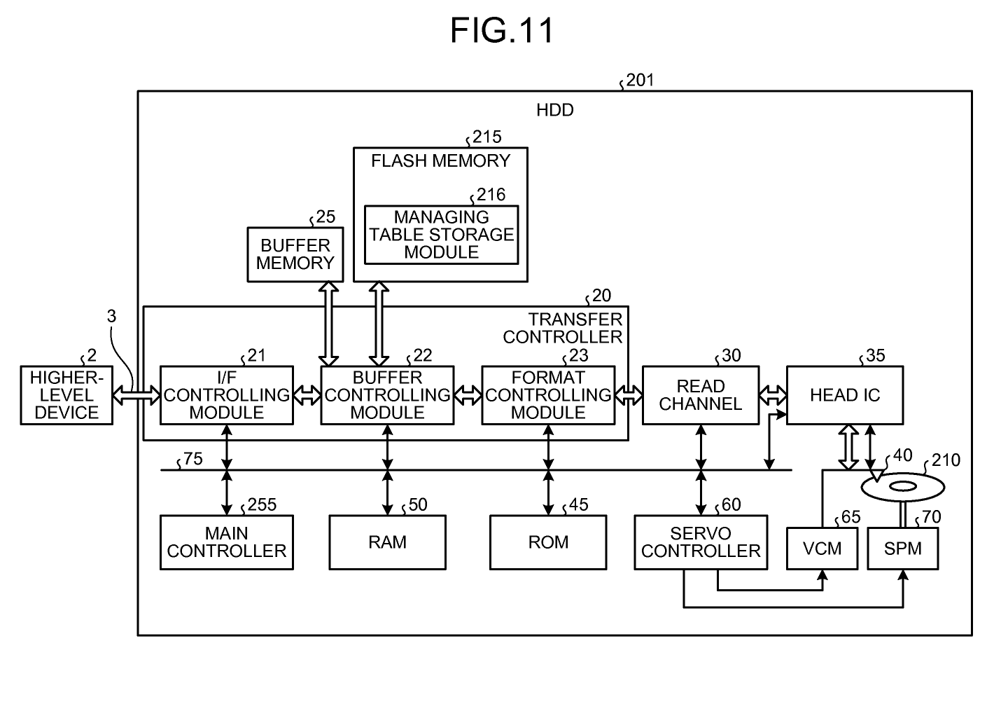

FIG. 11 is a block diagram illustrating an exemplary structure of a HDD 201 according to the third embodiment. The HDD 201 illustrated in FIG. 11 is different from the HDD 1 according to the first embodiment in having a magnetic recording medium 210, a managing table storage area 216 in a flash memory 215, and a main controller 255. Therefore, the magnetic recording medium 210 and the managing table storage area 216, which are the main differences between the first and the third embodiments, will be explained below. An explanation of the main controller 255 will be omitted in the description of the structure of the HDD, and will be given with reference to an operation performed by the HDD that is to be described hereunder.

In the magnetic recording medium 210, the statuses of storage areas storing therein data is managed by predetermined groups. In the third embodiment, each of the groups comprises a plurality of cells. A cell comprises a plurality of tracks that is physically located nearby, in one group, across a plurality of recording surfaces.

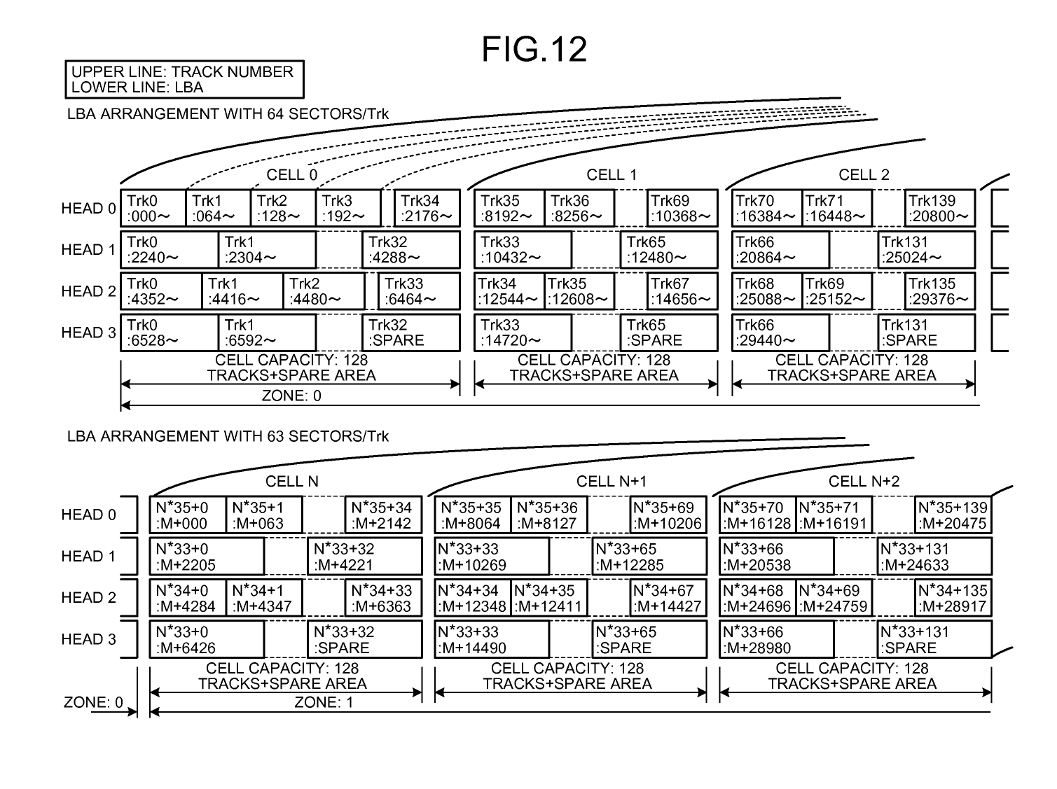

FIG. 12 is a schematic illustrating an example of the magnetic recording medium 210 according to the third embodiment, and is a cross-sectional view of the cell with four recording surfaces represented to be divided in doughnut-like shapes. In the example illustrated in FIG. 12, the number of tracks per cell is set to 128, and a spare area in the size of seven tracks is prepared at the end of each of the cells (on the recording surface corresponding to the Head 3). The positions of the spare areas may be also distributed over each of the recording surfaces. In the example illustrated in FIG. 12, the further to the inner side a zone is located, the smaller the number of sectors in a track is. The number of sectors per track is set to 64 in the outermost Zone 0, and the number of sectors per track is set to 63 in the Zone 1 located inner to the Zone 0.

The managing table storage area 216 stores therein a managing table in which indexes representing the groups are associated to bit information pieces representing the statuses of the storage areas belonging to the groups. In the groups, the statuses of the storage areas of the magnetic recording medium 210 are managed. Especially the managing table according to the third embodiment uses information on a plurality of upper bits in the cell number in the magnetic recording medium 210 as the indexes representing the groups in which the statuses of the storage areas of the magnetic recording medium 210 are managed.

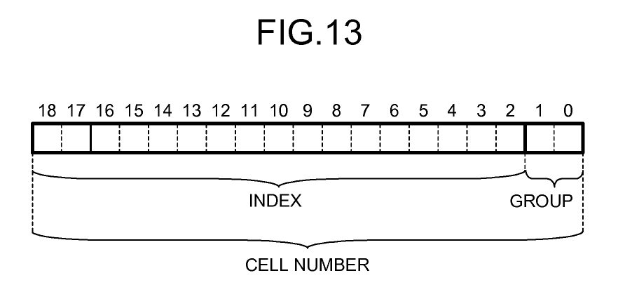

FIG. 13 is a schematic illustrating an example of a data structure of the cell number in the magnetic recording medium 210. As illustrated in FIG. 13, the number of bits representing the cell number in the magnetic recording medium 210 is 19 bits. In the managing table according to the third embodiment, the cell represented by the lower two bits (the zeroth to the first bits) of the cell number illustrated in FIG. 13, that is, four cells are placed in one group; and values in the upper 17 bits (the second to the eighteenth bits) of the cell number are used as the indexes representing the groups.

Alternatively, all of the information on bits of the cell number of the magnetic recording medium 210 may be used as the indexes representing the groups in which the statuses of the storage areas of the magnetic recording medium 210 are managed. In this case, a cell itself is to be a group.

An operation performed by the HDD according to the third embodiment will now be explained. The writing process performed in the HDD 201 according to the third embodiment is the same as that indicated in the flowchart of FIG. 5 with the cylinders replaced with the cells; therefore, an explanation thereof is omitted herein.

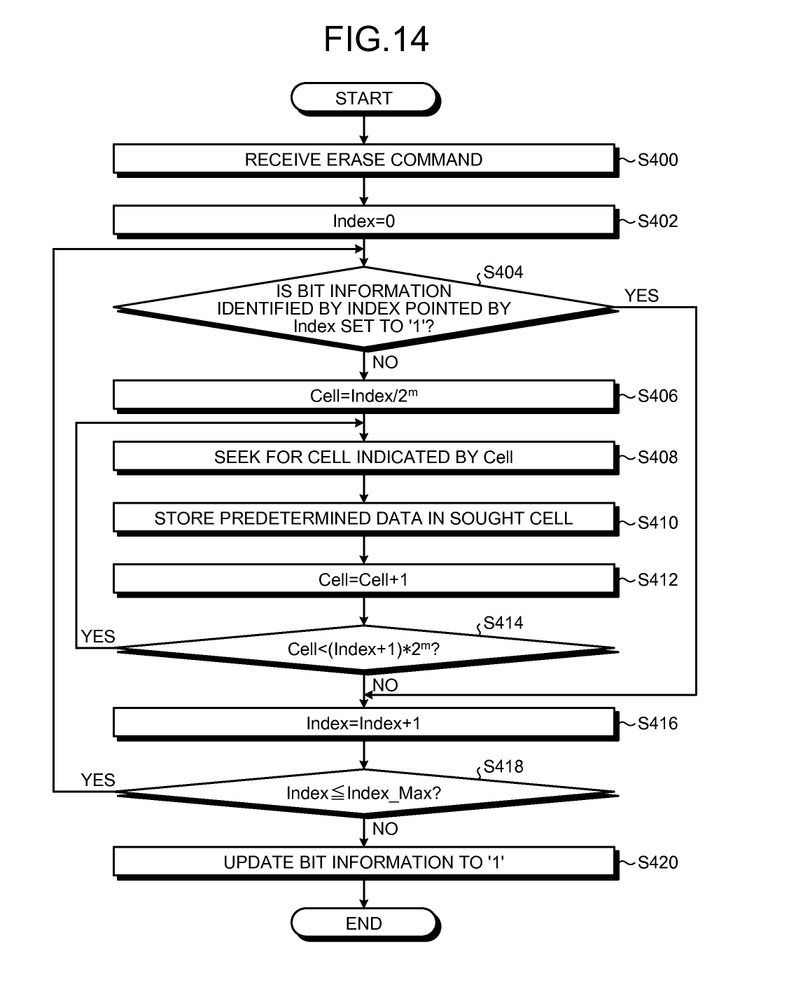

FIG. 14 is a flowchart indicating erasing process performed by the HDD 201 according to the third embodiment.

The processes at S400 to S404 are the same as those at S200 to S204 in the erasing process indicated in FIG. 6. At S404, if the bit information is set to ‘1’ (Yes at S404), the system control proceeds to S416.

If the bit information is not set to ‘1’ (that is, set to ‘0’) (No at S404), the main controller 255 sets the value of Cell that is a variable indicating the cell number to Index/2^{m} (S406). 2^{m} herein is a value indicating the number of cells in one group.

The main controller 255 then controls the servo controller 60 to start seeking the cell indicated by the Cell (S408).

Upon completing seeking, the transfer controller 20 then transfers the predetermined data to the magnetic recording medium 210 via the read channel 30, the head IC 35, and the head 40 to have the predetermined data stored in the sought cell (S410).

The main controller 255 then increments the value of the Cell (S412). If the incremented value of the Cell is smaller than (Index+1)*2^{m} (Yes at S414), the main controller 255 repeats the processes at S408 to S412. (Index+1)*2^{m} is a value indicating the maximum value of the cell number of the cells belonging to the group pointed by the index identified by the Index.

If the value of the Cell becomes equal to or more than (Index+1)*2^{m} (No at S414), the main controller 255 increments the value of the Index (S416).

The subsequent processes at S418 to S420 are the same as those at S226 to S228 in the erasing process indicated in FIG. 6.

As described in the third embodiment, when a cell structure is adopted in the HDD, the cell number or the information on a plurality of upper bits in the cell number of the magnetic recording medium is used as the indexes representing the groups in which the statuses of the storage areas in the magnetic recording medium are managed. Accordingly, the statuses of the storage areas in the magnetic recording medium can be managed. Therefore, even in the HDD according to the third embodiment, upon receipt of the instruction to initialize the data, only the storage areas that have stored therein the data can be initialized. In this manner, the data leakage can be prevented, as well as the data erasure can be speed up.

In the example explained in the first embodiment, the information on a plurality of upper bits of the cylinder number is used as the indexes representing the groups in which the statuses of the storage areas in the magnetic recording medium are managed. In an example explained in a fourth embodiment, information on a plurality of upper bits of a logical address is used as the indexes representing the groups in which the statuses of the storage areas in the magnetic recording medium are managed. In the explanation below, differences with the first embodiment will mainly be explained, and structural elements having the same function as those in the first embodiment will be given with the same names and the same reference numerals as those in the first embodiment, and explanations thereof will be omitted.

To begin with, a structure of a HDD according to the fourth embodiment will be explained.

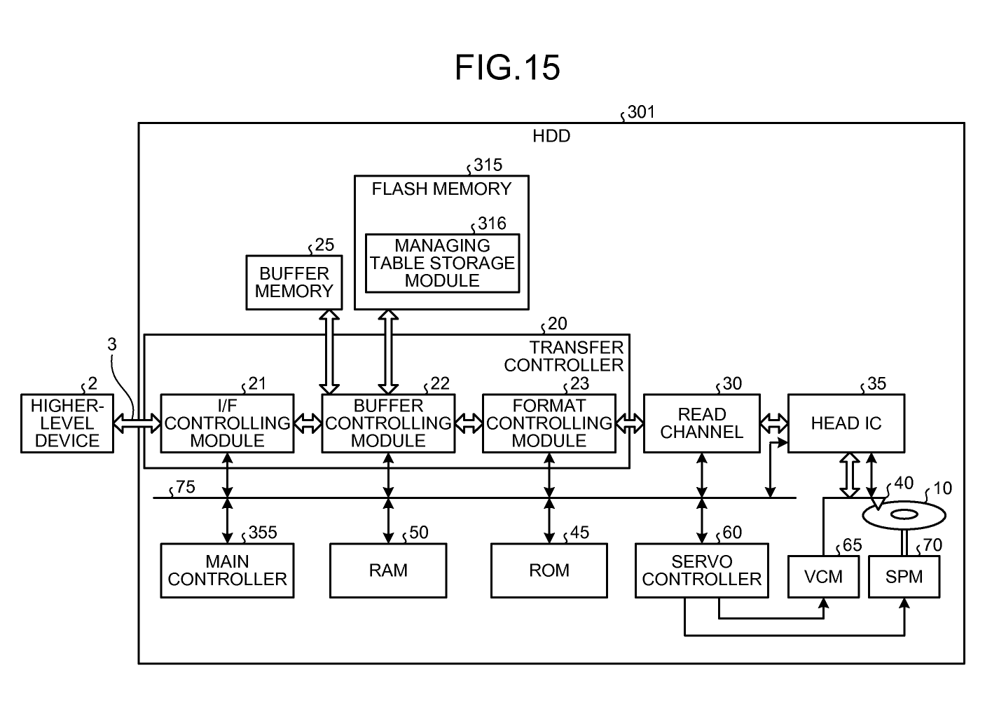

FIG. 15 is a block diagram illustrating an exemplary structure of a HDD 301 according to the fourth embodiment. The HDD 301 illustrated in FIG. 15 is different from the HDD 1 according to the first embodiment in having a managing table storage area 316 in a flash memory 315, and a main controller 355. Therefore, the managing table storage module 316, which is the main difference between the first and the fourth embodiments, will be explained below. An explanation of the main controller 355 will be omitted in the description of the structure of the HDD, and will be given with reference to an operation performed by the HDD that is to be described hereunder.

The managing table storage module 316 stores therein a managing table in which indexes representing the groups are associated with bit information pieces representing the statuses of the storage areas belonging to the groups. In the group, the statuses of the storage areas of the magnetic recording medium 10 are managed.

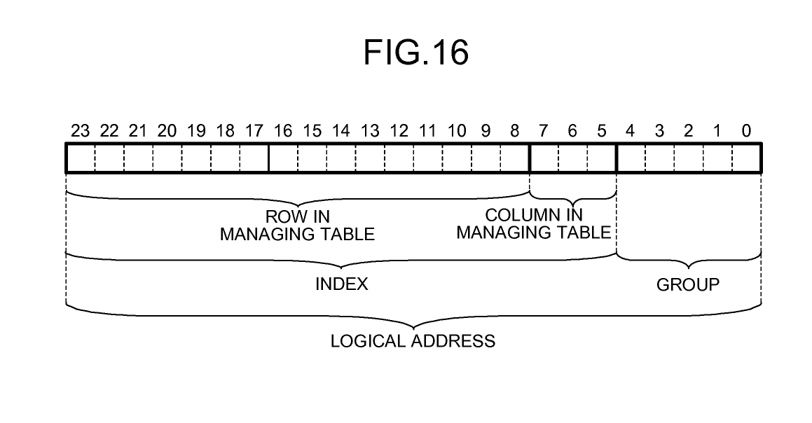

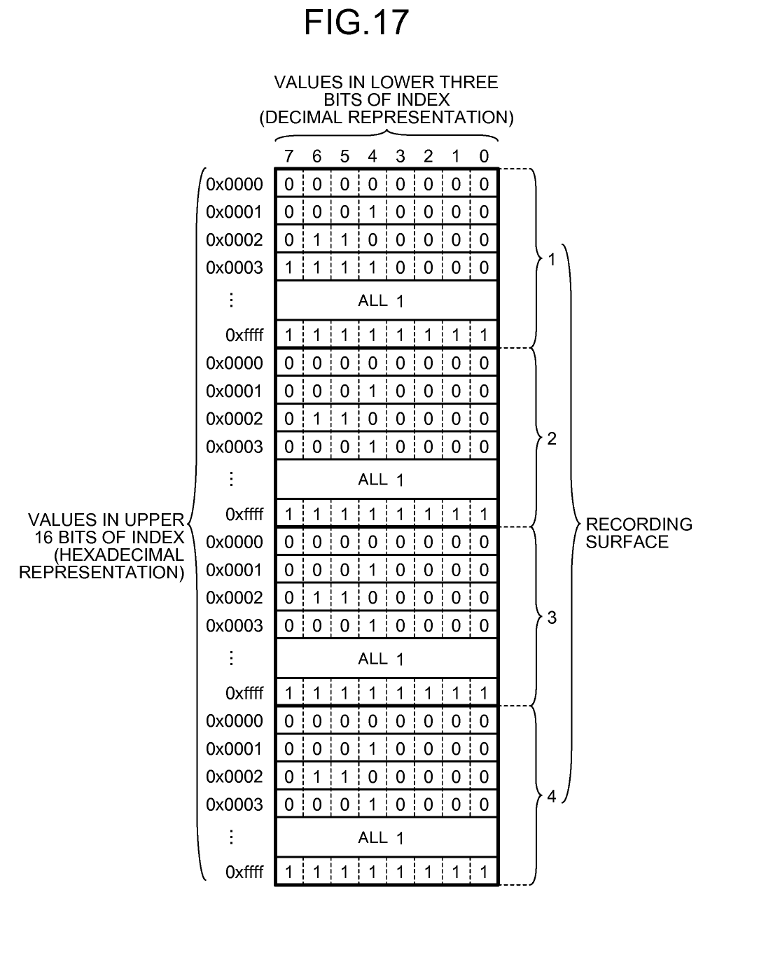

The managing table according to the fourth embodiment will now be explained more specifically. The managing table according to the fourth embodiment uses the logical address in the magnetic recording medium 10 as the indexes representing the groups in which the statuses of the storage areas in the magnetic recording medium 10 are managed. FIG. 16 is a schematic illustrating an example of a data structure of the logical address in the magnetic recording medium 10, and FIG. 17 is a schematic illustrating an example of the managing table according to the fourth embodiment.

As illustrated in FIG. 16, the number of bits representing the logical address in the magnetic recording medium 10 is 24 bits. In the managing table illustrated in FIG. 17, the storage areas represented by the logical addresses corresponding to the lower five bits (the zeroth to the fourth bits) of the logical address illustrated in FIG. 16 are placed in one group, and values in the upper 19 bits (the fifth to the twenty-third bits) of the logical address are used as the indexes representing the groups.

To explain in more detail, in the managing table illustrated in FIG. 17, the statuses of the storage areas belonging to the groups represented by the indexes are managed by using the values in the upper 16 bits of the indexes (the eighth to the twenty-third bits in the logical address) in the row, and the values in the remaining three bits (the fifth to the seventh bits of the logical address) in the column.

In the managing table illustrated in FIG. 17, a managing table is provided for each of the recording surfaces; however, when exactly the same areas in each of the recording surfaces are used, such as in a Redundant Arrays of Inexpensive Disks (RAID) configuration, the managing table may be shared among the recording surfaces. In this manner, the size of the managing table can be further reduced.

An operation performed by the HDD according to the fourth embodiment will now be explained. The writing process performed in the HDD 301 according to the fourth embodiment is the same as that indicated in the flowchart of FIG. 5; therefore, an explanation thereof is omitted herein.

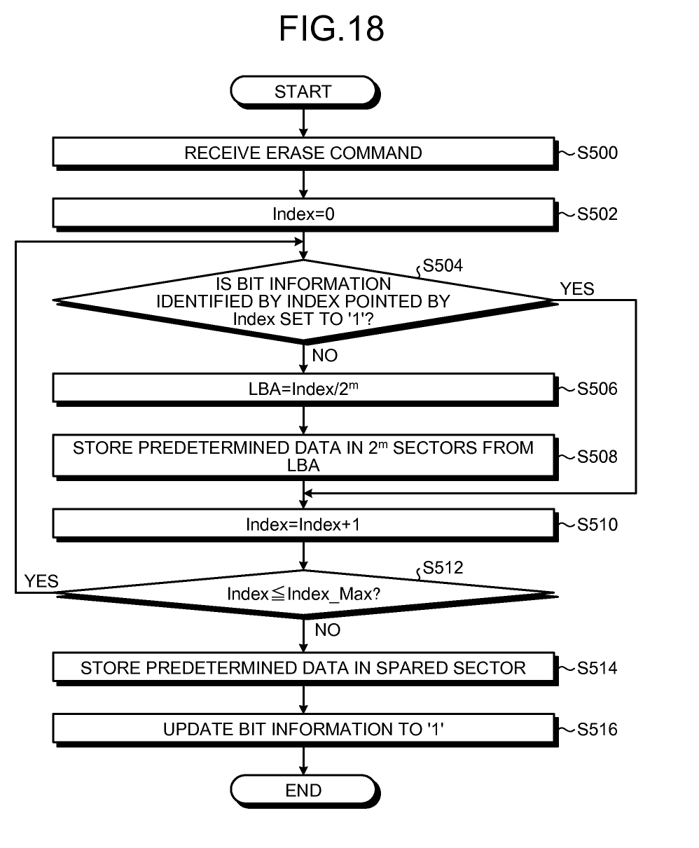

FIG. 18 is a flowchart indicating erasing process performed by the HDD 301 according to the fourth embodiment.

The processes at S500 to S504 are the same as those at S200 to S204 in the erasing process indicated in FIG. 6. At S504, if the bit information is set to ‘1’ (Yes at S504), the system control proceeds to S510.

If the bit information piece is not set to ‘1’ (that is, set to ‘0’) (No at S504), the main controller 355 sets the value of LBA that is a variable indicating the logical address to Index/2^{m} (S506). 2^{m} is a value indicating the number of logical addresses in one group.

The transfer controller 20 then transfers the predetermined data to the magnetic recording medium 10 via the read channel 30, the head IC 35, and the head 40 to have the predetermined data stored in the 2^{m} sectors from the sector indicated by the LBA (S508).

The main controller 355 then increments the value of the Index (S510). If the incremented value of the Index is equal to or less than the Index_Max (Yes at S512), the main controller 355 repeats the processes at S504 to S510.

When the value in the Index exceeds the Index_Max (No at S512), the transfer controller 20 transfers the predetermined data to the magnetic recording medium 10 via the read channel 30, the head IC 35, and the head 40 to have the predetermined data stored in the spared sector (spare area) (S514).

The main controller 355 then updates the value of a bit information piece set to ‘0’ to ‘1’ among the bit information pieces in the managing table stored in the managing table storage module 316 (S516).

As disclosed herein in the fourth embodiment, by using the information on the plurality of upper bits of a logical address in the magnetic recording medium as the indexes representing the groups in which the statuses of the storage areas in the magnetic recording medium are managed, the status of the storage areas of the magnetic recording medium can be managed. Therefore, in the HDD according to the fourth embodiment, upon receipt of the instruction to initialize the data, only the storage areas that have stored therein the data can be initialized. In this manner, the data leakage can be prevented, as well as the data erasure can be speed up.

In the fourth embodiment, the managing table is maintained in the HDD; however, the managing table may be maintained in a higher-level device. In this manner, because the statuses of the storage areas in the magnetic recording medium can be managed in the higher-level device, it becomes possible to prevent the data leakage as well as to speed up the data erasure even in an existing HDD.

Each of the bit information pieces in the managing table may be updated to the erased status after the HDD is incorporated into the higher-level device and initial data is stored in the incorporated HDD (for example, after pre-installing an operating system (OS) onto a personal computer (PC) that is the higher-level device). In this manner, the erasing process can be omitted for the OS or system data that do not require any secrecy protection, and the initialization can be executed by narrowing down the areas storing therein user data that might contain some personal information, which enables the erasing work to be sped up further.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data storage device, comprising:
a recording medium comprising storage areas;
a managing table storage module configured to store a managing table comprising bit information associated to indices representing predetermined groups of statuses of the storage areas, the bit information indicating the statuses of the storage areas of the predetermined groups, the bit information being initially set to an erased status indicating that no data is written thereto;
a transfer controller configured to transfer data to the recording medium in order to store the data in at least one of the storage areas, upon receiving a write command instructing to write the data to the recording medium from a higher-level device; and
a main controller configured to update at least one of the bit information of one of the predetermined groups comprising the at least one of the storage areas a stored status indicating that at least one of the storage areas comprises the data, wherein
the transfer controller is configured to transfer predetermined data to the recording medium in order to overwrite the at least one of the storage areas by the transferred data, upon receiving an erase command instructing to initialize the recording medium from the higher-level device, and
the main controller is configured to update the at least one of the bit information updated to the stored status to the erased status.

2. The data storage device of claim 1, wherein
the managing table storage module is a flash memory, and
the at least one of the bit information updated to the erased status is set to 1, and the at least one of the bit information pieces updated to the stored status is set to 0.

3. The data storage device of claim 1, wherein
the recording medium is a disk-like magnetic recording medium, and
information on a plurality of upper bits of a cylinder number of the magnetic recording medium is used as the indices representing the predetermined groups, in the managing table.

4. The data storage device of claim 1, wherein
the recording medium is a disk-like magnetic recording medium, and
information on a bit of a head number and information on a plurality of upper bits of a track number of the magnetic recording medium are used as the indices representing the predetermined group, in the managing table.

5. The data storage device of claim 1, wherein
the recording medium is a disk-like magnetic recording medium, and
a cell number of a cell configured by a group of a plurality of tracks physically nearby on the magnetic recording medium or information on a plurality of upper bits of the number of the cell is used as the indices representing the group, in the managing table.

6. A data erasing method, comprising:
receiving a write command instructing to write data to a recording medium from a higher-level device;
transferring the data to the recording medium in order to store the data in at least one of storage areas of the recording medium;
updating at least one of bit information of one of predetermined groups of statuses of the storage areas, comprising the at least one storage area comprising a stored status indicating that the at least one storage area comprises the data, the bit information being associated to indices representing the predetermined groups in a managing table, the bit information indicating the statuses of the storage areas of the predetermined groups, the bit information being initially set to an erased status indicating that no data is written to the storage areas;
receiving an erase command instructing to initialize the recording medium from the higher-level device;
transferring predetermined data to the recording medium in order to overwrite the at least one storage area by the transferred data; and
updating the at least one of the bit information updated to the stored status to the erased status.
